(19) United States
(12) Patent Application Publication
(10) Pub. No.: US 2003/0207026 A1
(43) Pub. Date: Nov. 6, 2003

(54) Sprayable powderous composition for underbody protection or sealant

(76) Inventors: Karl Wesch, Waldbrunn (DE); Hanno-Martin Becker, Wiesloch (DE); Dirk Reitenbach, St. Leon-Rot (DE)

Correspondence Address: HENKEL CORPORATION, 2500 RENAISSANCE BLVD, STE 200, GULPH MILLS, PA, 19406, US

(21) Appl. No.: 10/427,099

(22) Filed: Apr. 30, 2003

Related U.S. Application Data
(63) Continuation of application No. 09/762,737, filed on Jun. 14, 2001, now abandoned.
Application No. 09/762,737 is a 371 of international application No. PCT/EP99/05623, filed on Aug. 3, 1999.

(30) Foreign Application Priority Data
Aug. 12, 1998 (DE) 198 36 491.1

(51) Int. Cl. B05D 1/04; B05D 3/02

(52) U.S. Cl. 427/180; 427/475; 427/385.5

(57) ABSTRACT

A composition for spray coating metal parts for protection and sealing. The composition is a water, volatile organic solvent and liquid plasticizer free thermoplastic powder composition having a particle size below 700 μm. A portion of the polymers carry polar functional groups.

### RELATED APPLICATIONS

This application is a continuation of U.S. Ser. No. 09/762,737, filed Jun. 14, 2001 which claims priority from a 37 U.S.C. 371 filing of PCT/EP99/05623, filed Aug. 3, 1999 claiming priority from DE 198 36 491.1 filed Aug. 12, 1998, the entire contents of each application are incorporated herein by reference.

### FIELD OF THE INVENTION

The present invention relates to a sprayable powderous composition based on thermoplastic polymer powders and also to its preparation and use as underbody protection or sealant.

### BACKGROUND OF THE INVENTION

In order for them to retain their suitability for use, articles comprising metallic tools, in vehicle construction, mechanical engineering and appliance construction often have to be provided with coatings which are abrasion-resistant. In vehicle construction, especially in automotive construction, these articles comprise, in particular, the underbody region and also the wheel arches and the so-called sills. Additionally, it is necessary to seal off spot-welded or otherwise mechanically fastened seams against penetration by dust and water. In vehicle construction, this has been done in the past primarily using plastisols, i.e., dispersions of organic polymers in plasticizers, which gel when heated to relatively high temperatures and harden on cooling. The plastisols used for this purpose are dispersions based on (meth)acrylate homopolymers and copolymers, styrene copolymers and also, in particular, polyvinyl chloride homopolymers and/or copolymers in plasticizers. Frequently, alongside other constituents, these plastisol compositions comprise so-called extenders in the form of high-boiling hydrocarbons. Although the abovementioned plasticizers and the extenders are of low volatility, gelling in the coating ovens of the auto industry is always accompanied by evaporation of a small fraction of both constituents. This leads to emission problems and condensation problems in the coating ovens. Furthermore, despite modern process control, it is impossible to prevent fully what is known as overspray, i.e., the spraying of the plastisol into the surroundings of the application booth. This so-called overspray must be either disposed of or recycled into the product circuit by means of complex reprocessing methods.

There is therefore a need, especially for vehicle construction, to provide underbody protection compositions or sealing materials which are free from any solvents and plasticizers. In the past, compositions based on aqueous emulsions or dispersions have been proposed for this purpose but these have led to application problems in the normal production sequence of vehicles, since during the short drying times inherent in the process the water is unable to evaporate fully, or else evaporates but with the formation of bubbles in the coat. Furthermore, even aqueous dispersion and emulsion systems always still include small amounts of volatile organic solvents as so-called leveling assistants and/or film-forming agents.

The object was therefore to provide underbody protection compositions and/or sealant composition which are free both from solvents and plasticizers and from water.

### BRIEF DESCRIPTION OF THE INVENTION

In accordance with the invention, this object is achieved by the provision of sprayable, powderous compositions based on powderous thermoplastic polymers, these compositions being essentially free from water, volatile organic solvents and/or plasticizers which are liquid at room temperature. These compositions comprise one or more powderous thermoplastic polymers, at least some of the polymers containing polar, functional groups. Furthermore, these mixtures may comprise further organic or inorganic solids in powder form. These compositions are sprayed by electrostatic methods onto untreated metal surfaces, or onto metal surfaces which have been organically or inorganically pretreated and coated. As a result of this charging, the particles adhere to these metals immediately and also after several hours, even on vertical surfaces. By exposure to elevated temperature, this powder layer is melted and then gives a firmly adhering film on the substrate.

### DETAILED DESCRIPTION OF THE INVENTION

Similar powderous compositions had already been disclosed, in the form of so-called powder coating materials.

For instance, U.S. Pat. No. 4,865,882 describes a method of powder coating metallic articles. The powder coating composition contains from 80 to 97% of a modified polypropylene powder and from 20 to 3% of a polyethylene powder of very low density. These materials are mixed in the melt and formed into pellets in an extruder, and these pellets are then ground by cryomilling to give a powder having an average particle size of approximately 150 μm. The metallic articles to be coated, such as baskets, boards or automotive accessories, are then preheated to approximately 200 to 250° C. and subsequently immersed for a few seconds to a “Sprayable powderous composition for underbody protection or sealant”

The present invention relates to a sprayable powderous composition based on thermoplastic polymer powders and also to its preparation and use as underbody protection or sealant.

In order for them to retain their suitability for use, articles comprising metallic tools [sic] in vehicle construction, mechanical engineering and appliance construction often have to be provided with coatings which are abrasion-resistant. In vehicle construction, especially in automotive construction, these articles comprise, in particular, the underbody region and also the wheel arches and the so-called sills. Additionally, it is necessary to seal off spot-welded or otherwise mechanically fastened seams against penetration by dust and water. In vehicle construction, this has been done in the past primarily using plastisols, i.e., dispersions of organic polymers in plasticizers, which gel when heated to relatively high temperatures and harden on cooling. The plastisols used for this purpose are dispersions based on (meth)acrylate homopolymers and copolymers, styrene copolymers and also, in particular, polyvinyl chloride homopolymers and/or copolymers in plasticizers. Frequently, alongside other constituents, these plastisol compositions comprise so-called extenders in the form of high-boiling hydrocarbons. Although the abovementioned plasticizers and the extenders are of low volatility, gelling in the coating ovens of the auto industry is always accompanied by evaporation of a small fraction of both constituents. This leads to emission problems and condensation problems in the coating ovens. Furthermore, despite modern process control, it is impossible to prevent fully what is known as overspray, i.e., the spraying of the plastisol into the surroundings of the application booth. This so-called overspray must be either disposed of or recycled into the product circuit by means of complex reprocessing methods.

There is therefore a need, especially for vehicle construction, to provide underbody protection compositions or sealing materials which are free from any solvents and plasticizers. In the past, compositions based on aqueous emulsions or dispersions have been proposed for this purpose but these have led to application problems in the normal production sequence of vehicles, since during the short drying times inherent in the process the water is unable to evaporate fully, or else evaporates but with the formation of bubbles in the coat. Furthermore, even aqueous dispersion and emulsion systems always still include small amounts of volatile organic solvents as so-called leveling assistants and/or film-forming agents.

The object was therefore to provide underbody protection compositions and/or sealant composition which are free both from solvents and plasticizers and from water.

In accordance with the invention, this object is achieved by the provision of sprayable, powderous compositions based on powderous thermoplastic polymers, these compositions being essentially free from water, volatile organic solvents and/or plasticizers which are liquid at room temperature. These compositions comprise one or more powderous thermoplastic polymers, at least some of the polymers containing polar, functional groups. Furthermore, these mixtures may comprise further organic or inorganic solids in powder form. These compositions are sprayed by electrostatic methods onto untreated metal surfaces, or onto metal surfaces which have been organically or inorganically pretreated and coated. As a result of this charging, the particles adhere to these metals immediately and also after several hours, even on vertical surfaces. By exposure to elevated temperature, this powder layer is melted and then gives a firmly adhering film on the substrate.

Similar powderous compositions had already been disclosed, in the form of so-called powder coating materials.

For instance, U.S. Pat. No. 4,865,882 describes a method of powder coating metallic articles. The powder coating composition contains from 80 to 97% of a modified polypropylene powder and from 20 to 3% of a polyethylene powder of very low density. These materials are mixed in the melt and formed into pellets in an extruder, and these pellets are then ground by cryomilling to give a powder having an average particle size of approximately 150 μm. The metallic articles to be coated, such as baskets, boards or automotive accessories, are then preheated to approximately 200 to 250° C. and subsequently immersed for a few seconds to a few minutes in a fluidized bed which comprises the powder coating composition. As a result, a layer of the powder composition is deposited on the hot metal article. After coating, the metallic article is heated at from 160 to 230° C. for a prolonged period in order to effect uniform melting of the surface of the coating obtained. Underbody protection coatings and seam seals are not disclosed in this document.

U.S. Pat. No. 5,498,783 describes a powder coating composition which crosslinks thermally and comprises a powderous mixture of a polyester resin containing on average two or more carboxyl groups, a first crosslinker, which is reactive toward the carboxyl groups of the polyester resin, a further reactive acrylate copolymer, and a second crosslinker, the second crosslinker being intended to be reactive toward the reactive functionality of the acrylate copolymer. Owing to their strong thermal crosslinking, however, such compositions are suitable only for coating applications which demand great hardness. For underbody protection applications and for seam seals, where high flexibility is required, these compositions are unsuitable.

Similar comments apply to the powder coating materials disclosed in EP-A-404960, based on ethylene copolymers, an epoxy resin, and a curing agent for the epoxy resin. In this case, the ethylene copolymer is said to contain from 0.5 to 10% by weight of structural elements which originate from a comonomer containing carboxylic anhydride, and from 3 to 40% by weight of a structure which hail from an olefinically unsaturated carboxylic acid monomer. In accordance with the teaching of this document, the powder coating composition disclosed therein is said to be suitable for protecting metallic substrates against corrosion induced by stone chipping. In accordance with the teaching of this document, normal thermoplastic resin compositions, which do not have a high degree of thermal crosslinking, are unsuitable for producing a stonechip protection coating, since according to this teaching the thermoplastic resins have a small adhesion effect on the substrate.

WO 87/02043 discloses a powder coating composition comprising a solid powderous epoxy resin having an average epoxide functionality per molecule of more than 2, and a solid curing agent for this epoxy resin. The solid epoxy resin is a polyfunctional polyglycidyl ether of a bisphenol compound, or a polyfunctional polyglycidyl ether of a polyglycol-modified bisphenol. It is disclosed that the powder composition may be sprayed directly onto phosphated, chromated or galvanized steel or onto chromated aluminum, to form a durable coating. No information is given about the suitability of such a composition for underbody protection applications.

WO 95/03344 describes a process for preparing a plastic which can be used as a powder coating material and/or hot-melt adhesive. For this purpose, polyolefins are subjected to a low-temperature plasma treatment in a frequency range form 30 kHz to 10 GHz. In accordance with the teaching of this document, a transparent coating of good adhesion may be applied to glass, at a processing temperature of 160° C., using powder coating materials produced in this way. It is further asserted that this composition is suitable for producing a type which have been coated with electrodeposition coatings, known as cathodic electrocoat materials. More recently, use has also been made of panels made of aluminum, aluminum alloys and magnesium alloys, so that the coating compositions or sealants are required to achieve good adhesion on all of the abovementioned substrates.

The polymer powders for use in accordance with the invention are thermoplastics. These thermoplastics are required to possess a melting range between 50° C. and 180° C. and to have, at least proportionally, polar groups having a pronounced dipole character and low steric bulk, in order to effect sufficient adhesion on any prior coating present, and/or on the metal surface. It has been found that coatings based on polymers which contain nitrogen-containing, polar groups, such as polyurethanes or polyamides, either as base polymer or copolymer, like epoxides as the main component or as admixtures to the powder mixtures, provide excellent adhesion to (cathodically) electrocoated substrates or other primers. Good adhesion results are likewise achieved with (meth)acrylic acid or (meth)acrylate copolymers. Furthermore, base polymers or copolymers which include vinyl acetate, such as polyvinyl acetate copolymers or ethylene-vinyl acetate polymers, for example, likewise effect adhesion to the abovementioned substrates.

As already mentioned, the underbody compositions or sealant compositions of the invention may be constructed on the basis of a thermoplastic powderous polymer containing polar groups; however, it is also possible to use mixtures of two or more thermoplastic polymers, in which case at least some of the polymers must carry polar groups. The polar functional groups may be selected from hydroxyl, amino, epoxy, carboxyl, ester, amide, urethane, isocyanurate, biuret, allophanate, blocked isocyanate, silanol, or alkoxysilane groups. It is readily possible to mix thermoplastic polymers containing a high fraction of the abovementioned polar groups with poly-α-olefin homopolymers and/or copolymers, in which case the poly-α-olefins should preferably have been prepared by means of a corona or plasma pretreatment. In the baking process of the coatings of the invention it is necessary to achieve effective and impervious coalescence of the polymer particles; therefore, only the abovementioned thermoplastic materials are suitable. Where powder mixtures are used, e.g., mixtures of polyurethanes or polyamides plus epoxides, there are strong indications that the crosslinking reaction of the polymer matrix with one another is not the reaction that is of primary significance, but rather that the primary reaction takes place, for example, with the cathodic electrocoat substrate (cathaphoretic deposition coating) or with the metallic substrate. As a result, there is good adhesion of the underbody protection compounds of the invention to the substrate; moreover, this ensures that not too high a level of crosslinking of the underbody protection composition takes place, since such high-level crosslinking would lead to embrittlement of the coating.

Particularly suitable for the compositions of the invention, for the abovementioned reasons, are, for example, the principal binder components of powder coating materials, provided crosslinkers, which are normally vital for powder coating applications, are not added to them, or are added only to a very small extent. Examples of binder systems of this kind are specified, inter alia, in D. A. Bate, “powder coatings, chemistry, manufacture and application”, SITA Technology, London, 1990, especially Chapters 2 to 4. Particular suitability is possessed, for example, by one-component epoxy powder coating materials having a softening point above 50° C., powder coating binders based on polyurethanes having a melting range between 80 and 100° C., melt index (MFI 190/2.16 in accordance with DIN 53735) 30-40 g/10 min, polyethylene-acrylate copolymer powders having a melt index of between 5 and 15 g/10 min, thermoplastic polyurethanes, polyamide powders having a melt index of between 15 and 40 g/10 min, ethylene-vinyl acetate copolymer powders, and also pretreated LDPE (low density polyethylene).

Besides the abovementioned polymeric constituents, the compositions of the invention may also comprise finely divided inorganic and/or organic (polymeric) fillers, pigments and/or aging inhibitors. Examples of suitable inorganic fillers are finely divided calcium carbonates in the form of the various ground or precipitated chalks, heavy spar, aluminum oxides, silicates. Colored pigments which may be used are carbon black, iron oxides, titanium dioxide, zinc oxide, and similar color pigments known per se. In this context it may be judicious, both for the fillers and for the pigments, to use surface-pretreated materials. Aging inhibitors which may be employed in this context are all conventional aging inhibitors for polymers, from the class of the UV stabilizers against photo-induced or photooxidative degradation of the polymers, antioxidants against thermal or thermooxidative degradation, and also stabilizers against hydrolytic degradation, or ozone protectants against attack by ozone. The nature and amount of the aging inhibitors are guided by the chemical structure of the polymers used.

In order for the compositions of the invention to be able to be sprayed without problems as powder coating materials, it is important that all powder constituents have an average particle size of below 700 μm, preferably below 200 μm, and with very particular preference below 80 μm. It is also necessary to ensure that the powder constituents do not exhibit any surface tackiness at temperatures below about 30 to 40° C., in order to prevent caking of the powder particles prior to spray application.

Investigations have shown that there is a direct dependency of the applicability by common application techniques on the particle size. The applicability denotes quantitative throughput per unit time and sufficient dry adhesion on metallic substrate. For this, the compositions have to meet the following requirements:

good fluidization in the fluidized bed

low conveying-air consumption

high quantitative throughput per unit time

accordingly, short coating time.

A low level of conveying-air consumption is a prerequisite for a uniform layer-thickness pattern and to prevent powder already applied from being blown away.

For the preparation of the powder mixtures it is necessary to select a process which avoids separation during application and during the recovery of overspray powder.

One suitable such process is based on a fluidization of the powder components in a stream of hot air and slightly below the melting temperature of the principal polymer. Different temperatures may be chosen in accordance with the adjuvants and the second polymer. One possibility is a process in which fluidization is carried out between 2 and 20° C. below the melting temperature of the principal polymer. Best results are achieved at a temperature range between 5 and 10° C. below the melting range. By slight sintering of the surface of the powder mixtures, sticking of the polymer particles to one another is prevented, so that the polymer powders are readily fluidizable, conveyable and sprayable. In the case of the preferred preparation process, the procedure is as follows: the premixed powders are blown into a reactor and fluidized, where they are subjected to a stream of hot air; subsequently, this powder/air mixture is discharged through a nozzle and cooled in a stream of cold air.

The use of plasma- or corono-pretreated polyolefins as sole base polymer for powder underbody protection coatings leads to unsatisfactory results, since these polymers do not achieve sufficient, relatively long-term powder adhesion on the substrates that are to be coated. Moreover, film adhesion after the baking process is unsatisfactory. It is assumed that, in the case of the plasma treatment, only superficial polymer chains of the particles are converted into polar functional groups and that these slight charges are inadequate for effecting any satisfactory, or at least adequate, powder adhesion and/or film adhesion. It may, however, be rational to make proportional use of polyolefin powders pretreated in this way as adjuvants for other polymers.

In addition to the dip processes described at the outset, powder coatings are sprayed in the spray process, both by the method of corona charging and by the tribo process. The compositions of the invention may be applied by both of the last-mentioned application processes, where particular preference is given to the tribo process, since by means of this process it is possible to obtain a better throwing power at edges and angles and thus a better coating. In order to maximize the efficiency of application of the coating composition, the application device, powder circuit and powder quality must be optimally matched to one another so that there are no system-related interruptions to operation. Besides the good fluidizability of the powder composition, already mentioned above, in the tribo process the powder must also generate a minimum frictional charge at a given airspeed. Suitable test equipment exists for determining the triboelectric chargeability, e.g., a current-charge-time meter (I-Q-T meter). The aim here is to achieve a minimum discharge current of from 1.7 to 2.5 μA at an air rate of 1.8 m³/h (s.t.p.) (cubic meters per hour at standard temperature and pressure).

With this spraying process, as is known, air is the conveying medium used; air is necessary not only for conveying but also for metering and for generating the triboelectric charge. For economic application, it must be ensured that the air rate for conveying, metering and triboelectric air is as small as possible. It should not exceed 7.5 m³/h. For this total air rate to be sufficient for conveying, spraying and charging the powder, the fine fraction of the powder, i.e., the fraction below 8 μm, should be as small as possible. A reduction in the air rate, especially in the conveying air rate, is also desirable in order to minimize the abrasive wear of the application devices. Uniform powder ejection is the result of effective fluidization in the powder supply vessel.

In direct comparison with a very high-quality underbody protection based on a PVC plastisol of the prior art, the underbody protection coatings in accordance with the present invention give abrasion values which are far above the level known at present. As a result, it is possible to reduce the thickness of the coating considerably. Furthermore, the coating compositions of the invention are notable for a significantly reduced specific weight in comparison to the PVC plastisols, so that, through both factors, a distinct reduction in weight of a vehicle is achieved.

In the case of the inventive use of the aforementioned powder compositions as underbody protection, i.e., in the underbody region of the vehicle, in the wheel arches, or as sill protection, coat thicknesses of between 100 μm and 900 μm, preferably between 150 and 400 μm are applied. These coatings are then converted into films in the paint drying ovens, in the normal sequence of the vehicle manufacturing process. The process temperatures commonly available here for film formation are between 110° C. and 180° C., preferably up to 160° C., in a period of between about 15 and 30 minutes.

For application as seam sealing material, which is applied, inter alia, in the interior of the vehicle as well, these seam sealings may also be cured specifically with the aid of lasers.

Adhesion tests following condensation testing or salt spray testing, and also low-temperature behavior in accordance with the requirements of present specifications for underbody protection compositions of worldwide automobile manufacturers, are met with the powder materials of the invention.

Below, the invention will be elucidated further with reference to a number of implementational examples.

### EXAMPLE 1

A powder mixture was prepared from the following constituents:

| | |
|---|---|
| Polyepoxide powder | 49.7% by weight |
| (softening range > 50° C.) | |
| Polyethylene powder, low density | 48.5% by weight |
| Carbon black, Printex XE 1 (Degussa) | 0.1% by weight |
| Precipitated coated chalk Winofil SPT | 0.5% by weight |
| Aluminum oxide powder | 1% by weight |

The abovementioned powder mixture was ground to different particle size ranges and then fluidized, by fluidizing the powder components in a stream of hot air at slightly below the melting temperature of the principal polymer, and subsequently discharged through a nozzle and cooled in a stream of cold air. To determine the best applicability, the following particle size ranges were investigated:

| Ex- | | Conveying | | | |
|---|---|---|---|---|---|
| am- | Particle | air | Metering air | | Throughput |
| ple | size (μ) | (m³ (s.t.p.)) | (m³ (s.t.p.)) | Fluidizing | (g/30 sec) |
| 2 | 0-80 | 1.7 | 1.5 | 0.5 | 150 |
| 3 | 0-200 | 2.3 | 1.0 | 1.0 | 100 |
| 4 | 0-400 | 3.0 | 0.7 | 1.5 | 80 |
| 5 | 80-200 | 3.4 | 0.5 | 1.6 | 80 |
| 6 | 100-400 | 4.0 | 0.5 | 2.0 | 35 |

It was found, with optimization to the lowest possible conveying air with good throughout, that a particle size distribution of ≦200μ is appropriate. Best results are achieved at particle sizes ≦80μ.

### Comparative Results of Different Underbody Protection Coatings

| | Plasma-pre- | | |
|---|---|---|---|
| | treated | | |
| | polyolefin | Powder coating | Inventive powder |
| | of the | material of | underbody protection |
| Property | prior art | the prior art | of Example 1 |
| Dry adhesion | sat. | sat. | sat. |
| Adhesion | unsat. | sat. | sat. |
| after baking | | | |
| (20 min/160° C.) | | | |
| Maximum | 200 | 300 | 700 |
| achievable | | | |
| coat | | | |
| thickness | | | |
| (μ) | | | |
| Abrasion | 15 | 20 | 128 |
| resistance | | | |
| (Sablux | | | |
| 200 μ, sec) | | | |
| Adhesion | unsat. | Sat. | sat. |
| after | | | |
| constant | | | |
| condensation | | | |
| conditions | | | |
| Low- | unsat. | Unsat. | sat. |
| temperature | | | |
| flexural | | | |
| test (−40° C.) | | | |

From these comparative results it is clear that a plasma-pretreated polyolefin powder in accordance with the prior art (analogous to WO 95/03344) gives satisfactory results in none of the criteria which are important for underbody protection coatings, except for dry adhesion. A conventional powder coating material of the prior art is unsuitable for an underbody protection composition in respect of the maximum achievable coat thickness and in respect of the abrasion resistance and in respect of the low-temperature flexural test.

In analogy to Example 1, powder mixtures were prepared on the basis of different binders. These powder mixtures were then used to coat cathodic electrocoated metal panels and baked at 150 or 170° C. The quality of the film was subsequently assessed with regard to visual appearance, expansion, and adhesion behavior. Additionally, the abrasion resistance was measured. For comparison purposes, the same measurements were carried out on a high-quality thin-film PVC plastisol, Terotex 3028 from Henkel Teroson. The results are set out in the table below.

| | | | | | | | | Adhesion | | |
|---|---|---|---|---|---|---|---|---|---|---|
| | | | | | | | | after | | |
| | Polymer | Particle | Melting | Film | | Adhesion | Adhesion | condensation | Coat | Abrasion |
| Example | binder | size | range | quality | Extension | 150° C. | 170° C. | exposure | [μm] | [kg] |
| 7 | PU | <200 | 80-100° C. | slightly | flexible | 10 | 10 | 10 | 281 | 20.84 |
| | | | | rough | | | | | | |
| 8 | PE co- | <500 | 100° C. | rough/ | flexible | 10 | 10 | 10 | 930 | 16.66 |
| | polymer | | | wavy | | | | | | |
| 9 | PU | <200 | 70° C. | rough | flexible | 10 | 10 | 10 | 280 | 22.54 |
| Compar- | Terotex | — | — | smooth | flexible | 10 | 10 | 10 | 230 | 12.28 |
| ative | 3028 | | | | | | | | | |
| 10 | PE co- | <500 | 100° C. | rough/ | flexible | 10 | 10 | 10 | 250 | 8.33 |
| | polymer | | | wavy | | | | | | |
| 11 | Epoxide | <80 | 120° C. | smooth | brittle | 10 | 10 | 10 | 250 | 8.33 |
| 12 | Copolyamide | <200 | 115-120° C. | smooth | solid | | 10 | 10 | 250 | 6.94 |

### Parameters for the Binders Used

| | |
|---|---|
| Example 7 | Polyurethane powder MFI: 35 g/10 min |
| Example 8 | Polyethylene-acrylate copolymer, MFI |
| | 8 g/10 min |
| Example 9 | Polyurethane powder 2, melting range |
| | (Kofler) 90-100° C. |
| Example 10 | Polyethylene-acrylate copolymer powder, |
| | MFI 9 g/10 min |
| Example 11 | Epoxide powder, melting range > 50° C. (DSC |
| | method, differential scanning |
| | calorimetry) |
| Example 12 | Copolyamide, MFI 18 g/10 min |

All of the coatings gave a continuous film suitable for underbody protection, which in almost all cases was highly flexible and extensible. All of the coatings showed excellent adhesion results (rating scale 10=very good, 0=completely unsuitable) not only after baking at 150° C. but also after baking at 170° C. and also after condensation climate testing (condensation exposure, 14 d/40° C.).

To determine the abrasion resistance by the BMW method, metal panels were produced with the coating compositions in the coat thicknesses stated in the table. The amount of gravel (in kg) required to penetrate the underbody protection coating completely was measured. From the abrasion values found it is clear that all of the underbody protection formulations give very good values, which even at low coat thicknesses are at least equal to those of high-quality plastisol coatings.

1.) Sprayable, powderous underbody protection or sealant composition based on powderous thermoplastic polymers, characterized in that it is essentially free from water, volatile organic solvents and/or liquid plasticizers.

2.) Composition according to claim 1, characterized in that the powder constituents have an average particle size below 700 μm, preferably below 200 μm, and in particular below 80 μm.

3.) Composition according to claim 1 or 2, characterized in that the thermoplastic polymer has a melting range of between 50° C. and 180° C.

4.) Composition according to at least one of the preceding claims, characterized in that a mixture of thermoplastic polymers is used.

5.) Composition according to at least one of the preceding claims, characterized in that the polymer or polymers comprise/comprises polar functional groups selected from hydroxyl, amino, epoxy, carboxyl, ester, amide, urethane, isocyanurate, biuret, allophanate, blocked isocyanate, silanol or alkoxysilane groups.

6.) Composition according to at least one of the preceding claims, characterized in that in addition to the thermoplastic polymer(s) it comprises finely divided fillers, pigments and/or aging inhibitors.

7.) Use of compositions based on powderous thermoplastic polymers according to at least one of claims 1 to 6 for coating in the underbody protection area or as sealants for sealing seams and joints in motor vehicle construction.

8.) Process for coating motor vehicles or motor vehicle parts in the underbody area or in the wheel arches, characterized by the following essential process steps:
spraying of a composition based on powderous thermoplastic polymers according to at least one of claims 1 to 6 onto the optionally cathodic electrocoat-precoated substrate with the aid of corona or tribo coating units,
followed by baking of the coating at temperatures between 110° C. and 180° C. for from 15 to 30 mi
